(19) United States
(12) Patent Application Publication
(10) Pub. No.: US 2010/0084800 A1
(43) Pub. Date: Apr. 8, 2010

(54) CLAMPING SYSTEMS FOR LARGE WORKPIECES

(76) Inventors: Richard A. Uhal, McKeesport, PA (US); Fred J. Gurney, Austin, TX (US); Frank M. Clark, Pittsburgh, PA (US)

Correspondence Address: REED SMITH LLP, P.O. BOX 488, PITTSBURGH, PA, 15230-0488, US

(21) Appl. No.: 12/570,719

(22) Filed: Sep. 30, 2009

Related U.S. Application Data
(60) Provisional application No. 61/101,904, filed on Oct. 1, 2008.

(51) Int. Cl. B25B 1/24

(52) U.S. Cl. 269/271

(57) ABSTRACT

Arrangements for clamping a large workpiece such as an I-beam to a precision assembly table (or fitup table) or other workpiece support. The clamping arrangement includes a base; a first track supported by the base; a first slider for sliding along the track; a second slider for sliding along the first track, wherein the first slider and the second slider are moveable relative to one another along the first track; a first spacer supported by the first slider; and a second spacer supported by the second slider; wherein the first spacer and the second spacer are adapted to grip the workpiece therebetween.

### CROSS-REFERENCE TO RELATED APPLICATION

This application claims the benefit under 35 U.S.C. §119(e) of the earlier filing date of U.S. Provisional Application Ser. No. 61/101,904 filed on Oct. 1, 2008, the entire disclosure of which is hereby incorporated by reference herein as if being set forth in its entirety.

### FIELD OF INVENTION

The invention relates to arrangements and processes for clamping a large workpiece.

### BACKGROUND OF THE INVENTION

Precision assembly tables (or fitup tables) historically have represented one highly useful arrangement for accommodating large workpieces such as magnetic levitation system guideways, wherein the workpieces are held securely for the purpose of undertaking precision work on the workpiece (such as welding). U.S. Pat. Nos. 6,453,544 and 6,202,275, both assigned to Maglev, Inc., provide examples and their disclosures are incorporated by reference herein.

Consequently, by way of providing general background and also of appreciating a context in which embodiments of the invention may readily be employed, FIG. 1 provides a perspective view of a conventional precision assembly table and basic components thereof. Additional details thereof may be appreciated from the prior Maglev patents cited hereinabove. It should be understood and appreciated that although a precision assembly table is shown in FIG. 1 that primarily relates to magnetic levitation guideway assembly, general principles relating to fitup tables in general as well as components or aspects of the table of FIG. 1 suitable for use with large workpieces in general can indeed be applicable to I-beams and other large workpieces as well as magnetic levitation guideways. It should also be readily understood and appreciated that fitup tables per se are provided as but one example of a possible mounting arrangement that could employ a clamping arrangement as broadly contemplated herein in accordance with at least one embodiment of the invention.

As shown, a precision assembly table may include a frame 1 connected to a surface 2 over which rigid bars 3 are positioned by adjustable support members 4 which are connected to the rigid bars 3 and the frame 1 and necessarily pass through the surface 2. As depicted, the frame 1 supports the surface 2 above the ground, and the frame further supports the adjustable support members 4 which protrude through the surface 2 to support the rigid bars 3 above the surface 2, above the frame 1, and above the ground. The frame 1 is very rigid and typically is connected to the factory floor or ground to prevent movement of the frame 1, thereby avoiding interference with the assembly. The frame 1 can be of a variety of configurations, provided that it provides a rigid and stable apparatus upon which the surface 2 and adjustable support members 4 can be connected. The surface 2 is utilized to shield the frame 1 and the apparatus associated with adjustable support members (see FIG. 3 of the prior Maglev patents, supra), from materials and damage resulting from the assembly operations taking place on top of the rigid bars 3.

The frame 1 may be used in connection with the adjustable support members 3 and rigid bars 2 without the presence of the surface 2, whereby the apparatus would perform the method of assembly in the same manner. The structures to be assembled are not required to, and preferably do not, rest on the surface 2 but rather on the tops of the rigid bars 3; this is readily depicted in FIG. 1, which shows a magnetic levitation guideway guide plate 5 positioned on the tops of the rigid bars 3.

The rigid bars 3 are typically parallel to each other and set apart from each other by a fixed distance (e.g., one foot apart). Other applications and particularly complex or curved contours may require more rigid bars 3 closer together. In some circumstances, the rigid bars 3 would not necessarily need to be parallel to each other. Some applications would not require as many rigid bars 3 such that the rigid bars 3 could be placed more than one foot apart. The skilled artisan is credited with the ability to ascertain any such requirements that such applications may require with respect to such spacing.

### SUMMARY OF THE INVENTION

Broadly contemplated herein, in accordance with at least one embodiment of the invention, are arrangements and processes for clamping a large workpiece such as an I-beam to a precision assembly table (or fitup table) or other workpiece support. Particularly contemplated herein, in accordance with at least one embodiment of the invention, are clamping arrangements that can be employed with fitup arms or other mounting arrangements for accommodating large workpieces such as I-beams.

Assembling a beam (e.g., an I-beam), including welding portions thereof, can be a complex process. It is important to be able to hold a beam securely and accurately during an assembly process.

In accordance with at least one embodiment of the invention, are arrangements and processes for clamping a large workpiece including a base; a first track supported by the base; a first slider for sliding along the track; a second slider for sliding along the first track, wherein the first slider and the second slider are moveable relative to one another along the first track; a first spacer supported by the first slider; and a second spacer supported by the second slider; wherein the first spacer and the second spacer are adapted to grip the workpiece therebetween.

### BRIEF DESCRIPTION OF THE DRAWINGS

FIG. 1 is a perspective view of a precision assembly table with basic components thereof according to the prior art.

FIG. 2 is a perspective view of a clamping arrangement that may be employed with a fitup arm or other suitable support arrangement in accordance with an embodiment of the invention.

FIG. 3 shows essentially the same arrangement as in FIG. 2, but in a different perspective view.

FIG. 4 shows a clamping arrangement, in accordance with an embodiment of the invention, as applied to an I-beam in a generally horizontal orientation (as opposed to the generally vertical orientation shown in FIGS. 2 and 3).

### DETAILED DESCRIPTION OF THE INVENTION

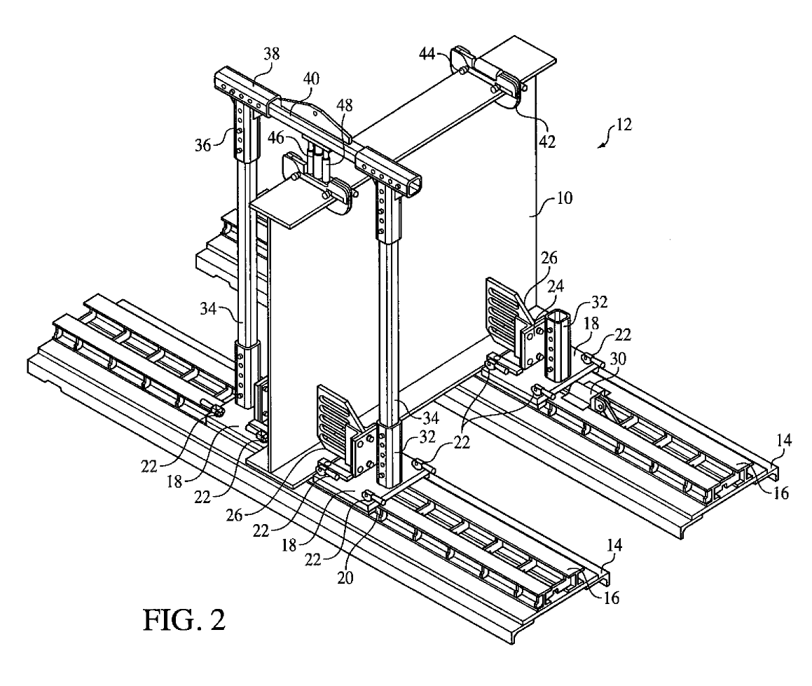

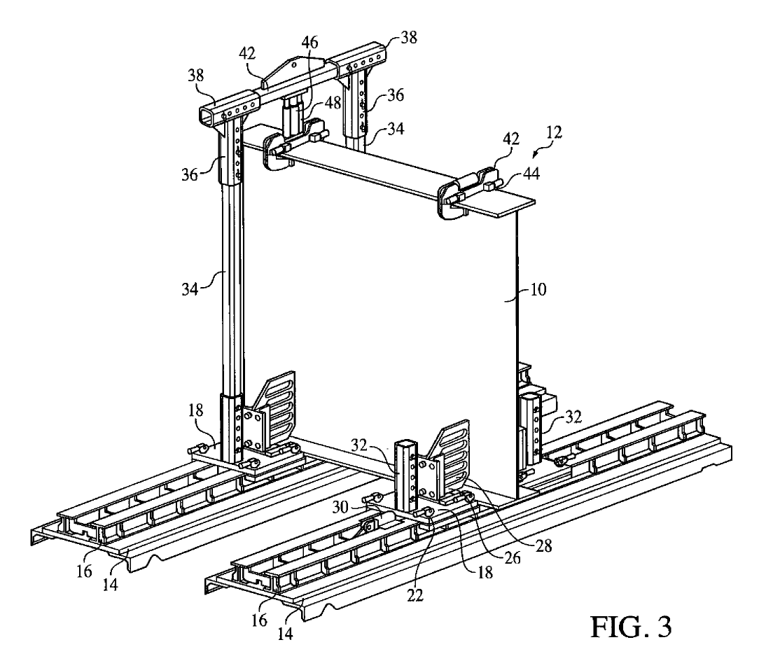

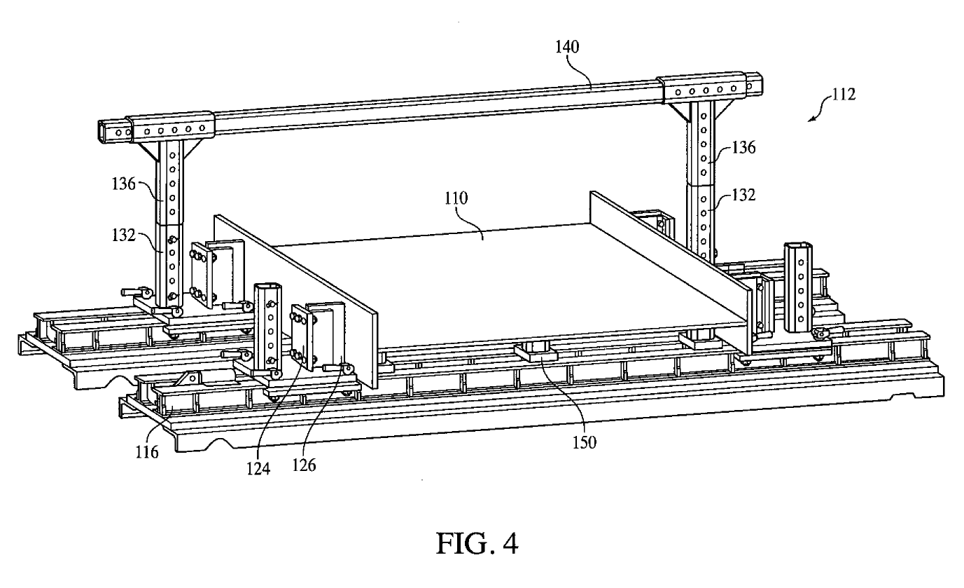

The disclosure now turns to FIGS. 2-4 in connection with embodiments of the invention. FIGS. 2-4 may henceforth be referred to collectively if not otherwise noted. In FIG. 2 various components are labeled; it should be understood that a label in FIG. 2 may be construed as referring to any similar component in FIG. 2 as well. Components in FIGS. 3 and 4 which are similarly configured or positioned as in FIG. 2 can also be taken as being referenced by labels from FIG. 2.

FIGS. 2-4 also specifically depict a workpiece in the form of an I-beam 10 (e.g., as may be employed in highway, bridge or other construction projects). However, it should be understood that embodiments of the invention as broadly contemplated herein may be considered as being applicable to a very wide variety of large workpieces other than I-beams. Accordingly, specific references to I-beams herethroughout should not be construed as necessarily limiting upon the embodiments of the invention.

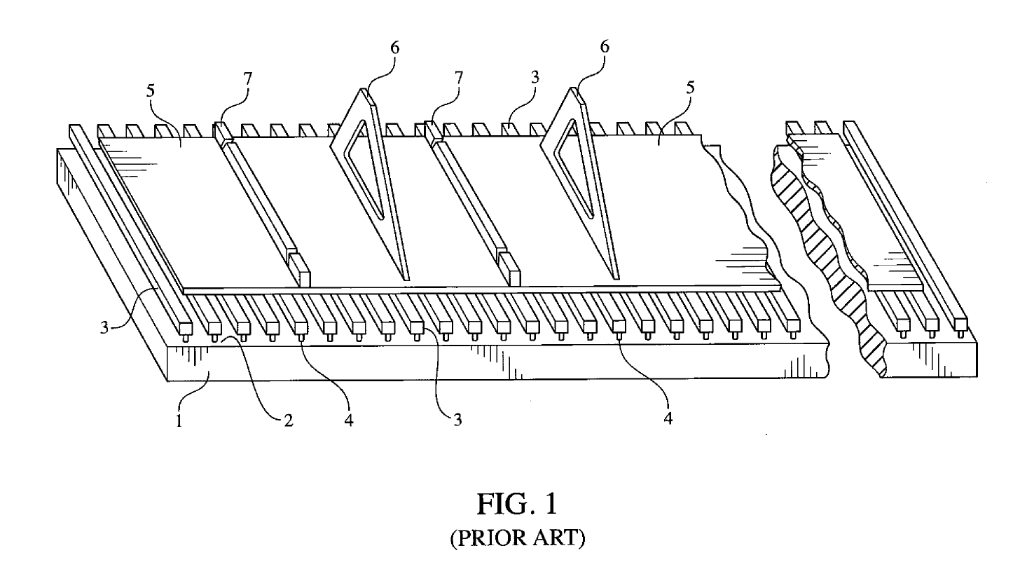

FIG. 2 illustrates in perspective view a clamping arrangement 12 in accordance with an embodiment of the invention that may be employed with a suitable support arrangement such as the one shown in FIG. 1. Shown are two cooperating sides of a clamp structure on each of two different base/track combinations, flanking an I-beam 10.

As shown, two parallel bases 14 (which themselves could correspond to fitup table arms as understood herein) may each support corresponding tracks 16 on which are disposed two sliders 18 each, wherein the sliders 18 can move towards and away from each other along the track 16. To this end, each slider 18 may have wheels or other similarly functioning elements 20 permitting such movement with respect to the track 16. Each slider 18 can selectively be fixed in position with respect to the track 16 via any suitable arrangement such as motion locks 22 as shown. Wherein, e.g., four pivotable elements per slider 18 may pivot with respect to each slider 18 such that in a first position of each motion lock 22, e.g., a horizontal position, the motion lock 22 serves to hold a corresponding portion of the slider 18 in place with respect to the track 16 while in a second position of each motion lock 22, e.g., a vertical position, the motion lock 22 releases a corresponding portion of the slider 18 from the track 16 to permit, with other motion locks 22 so positioned, the slider 18 to slide along the track 16.

Each slider 18 preferably has a gripper 24 configured for holding a side spacer 26. Each side spacer 26, as shown, may preferably have holes 28 in it so as to reduce heat conduction therethrough (e.g., if the I-beam 10 is to be welded or otherwise undergo a high-temperature treatment). Whereas the grippers 24 each preferably have a major dimension oriented perpendicularly with respect to a longitudinal axis of the corresponding track 16, the side spacers 26 preferably have a major dimension oriented in parallel to a longitudinal axis of the corresponding track 16.

As shown, cooperating pairs of sliders 18 (one pair per track 16) can preferably flank a lower (horizontal) portion of the I-beam 10 (that is to be worked on or assembled) and thus serve to hold that lower portion of the I-beam in place. Accordingly, a corresponding side spacer 26 may preferably be configured and dimensioned as to provide additional support to the vertical portion of the I-beam 10.

In order to provide fine positional adjustment of the sliders 18 with respect to the I-beam 10, an adjusting cylinder 30 (e.g., hydraulic cylinder) may preferably be provided for each slider 18 to cause each slider 18 to undergo limited displacement so as to finely position each slider 18 and/or ensure that each slider 18 is sufficiently brought into contact with the I-beam 10 as to adequately provide support for the I-beam 10. These cylinders 30 may travel with the sliders 18, to then be fixed with respect to the track 16 so as then be able to apply a force relative to the sliders 18, or they may each be selectively insertable into and mountable with respect to the track 16 as needed, or they may each be already fixedly mounted with respect to the track 16 in a manner to selectively accommodate a slider 18 to push a slider 18 when needed.

As shown, each slider 18 preferably includes a lower post 32 support configured for accommodating an interchangeable post 34 therein. The interchangeable posts 34 can be of essentially any suitable length so as to accommodate an I-beam 10 in accordance with applications broadly contemplated herein. FIGS. 2 and 3 relate to an I-beam 10 in vertical orientation, so the discussion at present will be directed the use of interchangeable posts 34 for such an orientation.

As shown, with respect to each track 16, two such interchangeable posts 34 may preferably extend upwardly from corresponding lower post 32 supports to upper post supports 36. These upper post supports 36 are each preferably integrated with horizontal lintel supports 38 configured for supporting an interchangeable horizontal support or lintel 40. Again, the interchangeable lintels 40 can be of essentially any suitable width so as to accommodate an I-beam 10 in accordance with applications broadly contemplated herein. (While only one set of interchangeable posts 34 and an interchangeable lintel 40 is shown in each of FIGS. 2 and 3, it should be understood that a similarly configured set can preferably be provided with respect to the other track 16.)

The interchangeable lintels 40 preferably serve to support an I-beam 10 at an upper portion of an I-beam 10 in a manner now to be discussed. As shown, a pair of sliding holders 42 may preferably be disposed on the upper (horizontal) portion of an I-beam 10. These sliding holders 42 preferably employ wheels or other suitable elements 44 to slidably displace with respect to the upper portion of the I-beam 10, along a direction parallel to a longitudinal axis of the upper portion of the I-beam 10. At each interchangeable lintel 40, a variable spacer 46 may preferably be provided to extend and provide support between the interchangeable lintel 40 and the sliding holder 42, all by way of exerting a downward force on the I-beam 10 to better support the I-beam 10 (in conjunction with the sliders 18 and associated components below). Preferably, the variable spacer 46 may include a hydraulic cylinder 48 to assist the spacer in extending between the lintel 40 and the sliding holder 42, thereby not only assisting in support of the I-beam 10 but to also provide fine positional adjustment of the sliding holder 42 against the I-beam 10.

FIG. 4 shows a clamping arrangement 112, in accordance with an embodiment of the invention, as applied to an I-beam 110 in a generally horizontal orientation (as opposed to the generally vertical orientation shown in FIGS. 2 and 3 and with similar elements having reference numeral advanced by 100 with respect to reference numeral used in FIGS. 2 and 3). Thus, essentially the same clamping arrangement as FIGS. 2 and 3 is shown, but with components differently configured. As shown in FIG. 4, a much longer lintel 140 is provided, while the interchangeable posts are removed. Preferably, the upper 136 and lower 132 post supports will be configured for readily integrating or mating with one another or may be configured for accommodating an interchangeable internal support therewithin, such as a rod that extends from an interior of the lower post support upwardly into an interior of the upper post support. It can also be seen in FIG. 4 that smaller spacers 126, different from than the ones shown in FIGS. 2 and 3 can be gripped by the grippers 124 and used for supporting the I-beam 110. Also shown are intermediate supports 150 that can selectively be placed on a track 116 to support the large horizontal portion of the I-beam. It can also be seen that here there is no support, analogous to the variable spacer of FIGS. 2 and 3, extending downwardly from the lintel.

In general overview, to the extent that any specific dimensions may appear in one or more drawings, it should be understood that these are provided merely by way of illustrative and non-restrictive example, and are not necessarily to be construed as limiting upon the embodiments of the invention. The same holds true for any relative or proportional dimensions that can be discerned from the drawings.

Without further analysis, the foregoing will so fully reveal the gist of the invention and its embodiments that others can, by applying current knowledge, readily adapt it for various applications without omitting features that, from the standpoint of prior art, fairly constitute characteristics of the generic or specific aspects of the invention and its embodiments.

If not otherwise stated herein, it may be assumed that all components and/or processes described heretofore may, if appropriate, be considered to be interchangeable with similar components and/or processes disclosed elsewhere in the specification, unless an express indication is made to the contrary.

If not otherwise stated herein, it may be assumed that all components and/or processes described heretofore may, if appropriate, be considered to be interchangeable with similar components and/or processes disclosed elsewhere in the specification, unless an express indication is made to the contrary.

If not otherwise stated herein, any and all patents, patent publications, articles and other printed publications discussed or mentioned herein are hereby incorporated by reference as if set forth in their entirety herein.

It should be appreciated that the apparatus and method of the invention may be configured and conducted as appropriate for any context at hand. The embodiments described above are to be considered in all respects only as illustrative and not restrictive.

What is claimed is:

1. An apparatus for clamping a workpiece comprising:
a base;
a first track supported by the base;
a first slider for sliding along the track;
a second slider for sliding along the first track, wherein the first slider and the second slider are moveable relative to one another along the first track;
a first spacer supported by the first slider; and
a second spacer supported by the second slider;
wherein the first spacer and the second spacer are adapted to grip the workpiece therebetween.

2. The apparatus of claim 1, wherein each of the first and the second spacers include throughholes to reduce heat conduction from the workpiece.

3. The apparatus of claim 1, further comprising at least one motion lock on each of the first and the second sliders for holding each of the first and the second sliders in a fixed position along the first track.

4. The apparatus of claim 1, further comprising an adjusting cylinder associated with each of the first and the second sliders to position each of the first and the second sliders along the first track.

5. The apparatus of claim 1, wherein the workpiece is an I-beam having a central portion between upper and lower cross portions, and wherein the first and second spacers each include a vertical surface adapted to hold the central portion of the I-beam against a vertical surface of the other of the first and second spacers.

6. The apparatus of claim 5, wherein the first and second spacers each include a horizontal surface for supporting the lower cross portion of the I-beam.

7. The apparatus of claim 5, further comprising a gripper on each of the first and the second sliders for respectively supporting the first and second spacers thereon.

8. The apparatus of claim 7, further comprising a second track spaced from and parallel to the first track.

9. The apparatus of claim 8, further comprising a third and a fourth slider moveable relative to one another along the second track, whereon the third and the fourth slider each has a gripper supported thereon for supporting the third and fourth spacers thereon, respectively.

10. The apparatus of claim 9, further comprising a first lower post supported on the first slider, a second lower post supported on the second slider, a third lower post supported on the third slider, and a fourth lower post supported on the fourth slider.

11. The apparatus of claim 10, further comprising a first vertical post supported on the first lower post, a second vertical post supported on the second lower post, a third vertical post supported on the third lower post, and a fourth vertical post supported on the fourth lower post.

12. The apparatus of claim 11, further comprising a first upper post supported on the first vertical post, a second upper post supported on the second vertical post, a third upper post supported on the third vertical post, and a fourth upper post supported on the fourth vertical post.

13. The apparatus of claim 12, further comprising a first lintel support supported on the first upper post, a second lintel support supported on the second upper post, a third lintel support supported on the third upper post, and a fourth lintel support supported on the fourth upper post.

14. The apparatus of claim 13, further comprising a first horizontal lintel supported between the first lintel support and the second lintel support, and second horizontal lintel supported between the third lintel support and the fourth lintel support.

15. The apparatus of claim 14, further comprising a first gripping assembly supported by the first lintel support for gripping the upper horizontal portion of the I-beam.

16. The apparatus of claim 15, further comprising a second gripping assembly supported by the second lintel support for gripping the upper horizontal portion of the I-beam.

17. The apparatus of claim 16, wherein each of the first and second gripping assemblies comprises a sliding holder which is slideable along the upper horizontal portion of the I-beam.

18. The apparatus of claim 17, wherein each of the first and second gripping assemblies comprises a variable spacer for varying the distance between on of the first and the second lintel supports and the sliding holder.

19. The apparatus of claim 5, wherein the first and second spacers each include a vertical surface for supporting one of the upper and lower cross portions of the I-beam.

20. The apparatus of claim 19, further comprising an intermediate support supported by the first track for supporting the central portion of the I-beam.
